(19) United States
(12) Patent Application Publication
(10) Pub. No.: US 2010/0325607 A1
(43) Pub. Date: Dec. 23, 2010

(54) Generating Code Meeting Approved Patterns

(75) Inventors: Erik Meijer, Mercer Island, WA (US); John Wesley Dyer, Monroe, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/486,156

(22) Filed: Jun. 17, 2009

(51) Int. Cl. G06F 9/44; G06F 9/45

(52) U.S. Cl. 717/106; 717/141; 717/142; 717/143; 717/115; 717/116; 717/137

(57) ABSTRACT

A compiler deployed as a component of an integrated development environment (“IDE”) is adapted to transform source code into target code that is correct by construction by complying with approved patterns described by an external configuration file which is utilized to parameterize the generation of the target code by a code generator. The approved patterns can express various design requirements, guidelines, policies, and the like that are acceptable for the target code to include as well as those which are unacceptable. A rules generator that applies regular tree grammar is configured to encapsulate the approved patterns in the external configuration file using a formal description that is machine-readable by the code generator. A source code translator is alternatively utilized to transform non-compliant source code into compliant source code that adheres to the approved patterns.

### BACKGROUND

Programmers face many challenges when developing code for programs, applications, and other software solutions. Programmers will typically deal with changing business and design guidelines throughout a project's development cycle. Communication among a myriad of stakeholders including project managers, developers, testers, and other team members must also be effectively managed. In addition, programmers need to achieve design, performance, user experience, and quality goals for their code while meeting expectations for cost and schedule.

As well as the challenges noted above, programmers are increasingly having to write code that meets with various regulatory and compliance guidelines. Such guidelines are typically not dictated by traditional technical considerations for the code per se, but are driven instead by legal, business, and/or policy considerations. Dealing with the various guidelines can often be inconvenient for programmers, and it is possible for even careful programmers to accidently write code that violates a guideline or other type of requirement. Guidelines may also change over time which can cause programmers to have to retroactively modify legacy code to conform to the changes. This can increase development costs as well as present an opportunity for bugs to be introduced into the code.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A compiler deployed as a component of an integrated development environment (“IDE”) is adapted to transform source, code into target code that is correct by construction by complying with approved patterns described by an external configuration file which is utilized to parameterize the generation of the target code by a code generator. The approved patterns can express various design requirements, guidelines, policies, and the like that are acceptable for the target code to include as well as those which are unacceptable. A rules generator that applies regular tree grammar is configured to encapsulate the approved patterns in the external configuration file using a formal description that is machine-readable by the code generator. A source code translator is alternatively utilized to transform non-compliant source code into compliant source code that adheres to the approved patterns.

In various illustrative examples, a rules generator may be utilized to transform informal descriptions of correct software behavior into rules that formalize acceptable patterns that are desirable for the target code to include (for example, to improve performance of code by speeding up execution and avoiding unbounded memory growth) and unacceptable patterns which the target code is expected to avoid (for example, to ensure compliance with legal guidelines such as license restrictions). During compilation of the source code, the code generator applies the rules from the external configuration file to generate compliant target code in view of the acceptable and unacceptable patterns. However, if the target code is constrained, and is not able to be generated in a manner that is compliant with one or more of the patterns (for example, because there is no defined workaround to avoid an unacceptable pattern), then the IDE can return an error or other warning back to the programmer to indicate that the source code cannot be reduced to compliant target code.

Advantageously, by moving the compliance mechanism down to a lower level in the IDE at the compiler, programmers are freed from having to take the approved patterns into consideration. They can write source code without taking any special actions but still know that the generated target code will be correct by construction. This freedom can be expected to improve productivity and reduce coding errors, particularly since programmers may often view compliancy issues as being difficult and constraining.

The rules in the external configuration file can be tailored to avoid generating code that exposes known bugs. In addition, the parameterization of the code generation from utilization of the external configuration file provides significant flexibility so that the generated target code may be readily tailored to suit different runtime environments and application configurations. Parameterization also accommodates changing policies without the compiler needing to be rewritten with each change.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative computing platform on which an integrated development environment (“IDE”) is operable;

FIG. 2 is a simplified functional block diagram of an illustrative IDE;

FIG. 3 shows the interaction between external items like files, folders, and references and the project system in the IDE;

FIG. 4 shows details of an illustrative compiler deployed in the IDE;

FIG. 5 shows details of an illustrative code generator that is parameterized using an external configuration file;

FIG. 6 shows an illustrative rules application that exposes a user interface to enable informal expressions of acceptable patterns to be formalized in the external configuration file;

FIGS. 7-19 show code samples that illustrate various acceptable and unacceptable patterns contained in HTML (Hypertext Markup Language) code;

FIG. 20 is a flowchart of an illustrative method that is performable by the code generator; and

FIG. 21 shows an illustrative source code translator which performs source-to-source transformation to produce code that is compliant with approved patterns.

Like reference numerals indicate like elements in the drawings.

### DETAILED DESCRIPTION

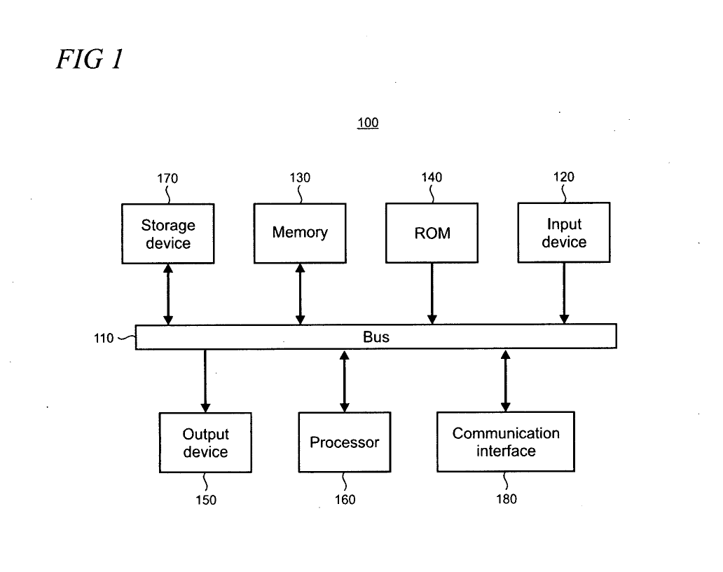

FIG. 1 shows an illustrative computing platform 100 such as a personal computer (“PC”), workstation, or server, on which an integrated development environment (“IDE”) that supports the present code generation is operable. The computing platform 100 is configured with a variety of components including a bus 110, an input device 120, a memory 130, a read only memory (“ROM”) 140, an output device 150, a processor 160, a storage device 170, and a communication interface 180. Bus 110 will typically permit communication among the components of the computing platform 100.

Processor 160 may include at least one conventional processor or microprocessor that interprets and executes instructions. Memory 130 may be a random access memory (“RAM”) or another type of dynamic storage device that stores information and instructions for execution by processor 160. Memory 130 may also store temporary variables or other intermediate information used during execution of instructions by processor 160. ROM 140 may include a conventional ROM device or another type of static storage device that stores static information and instructions for processor 160. Storage device 170 may include compact disc (“CD”), digital versatile disc (“DVD”), a magnetic medium, or other type of storage device for storing data and/or instructions for processor 160.

Input device 120 may include a keyboard, a pointing device, or other input device. Output device 150 may include one or more conventional mechanisms that output information, including one or more display monitors, or other output devices. Communication interface 180 may include a transceiver for communicating via one or more networks via a wired, wireless, fiber optic, or other connection.

The computing platform 100 may perform various functions in response to processor 160 executing sequences of instructions contained in a tangible machine-readable medium, such as, for example, memory 130, ROM 140, storage device 170, or other medium. Such instructions may be read into memory 130 from another machine-readable medium or from a separate device via communication interface 180.

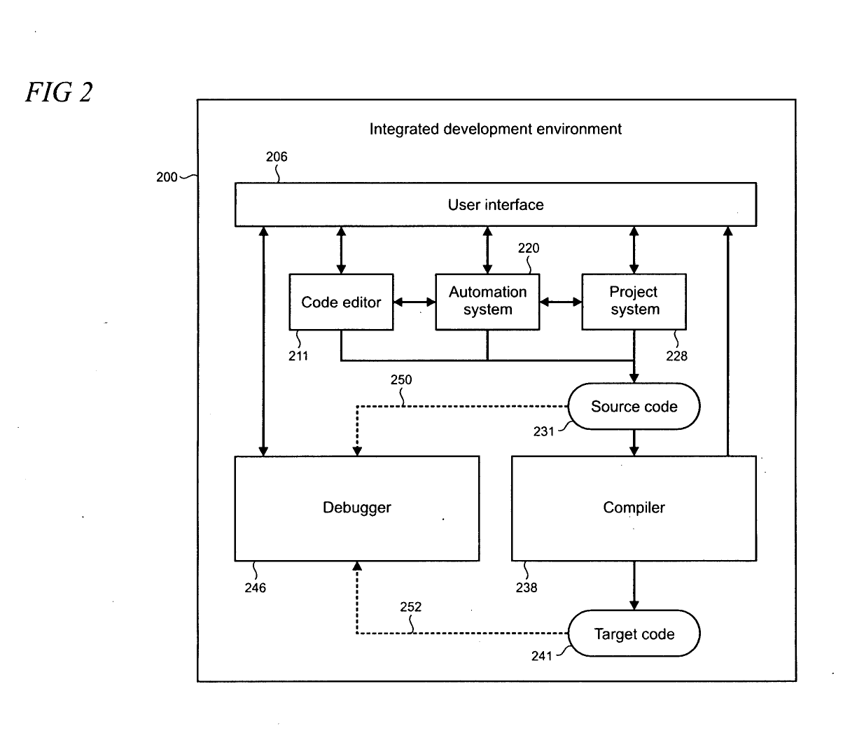

FIG. 2 is a simplified functional block diagram of an IDE 200 that is operable as one or more applications on the computing platform 100 (FIG. 1). IDEs are generally utilized to implement a programming environment that includes various tools to facilitate the development of code used in programs, applications, and other software solutions. IDEs typically enable programmers to write and edit source code, see errors in code construction or syntax, automate repetitive tasks and the building of code assemblies, browse class structures, compile the source code into target code (e.g., JavaScript, low-level assembly language, binary object code, etc.), and the like. In addition, some IDEs provide code templates, macros and other utilities; automatically create classes, methods, and properties; support code re-factoring; and support tools for collaboration among development team members and project management, among other features.

IDE 200 in this example includes a user interface 206 (which is typically implemented as a graphical user interface or “GUI”) that exposes development tools to a programmer, including a code editor 211, automation system 220, and project system 228. These tools are typically utilized to enable the programmer to readily generate source code 231 in some human-readable computer programming language (e.g. C#, Visual Basic, .NET programming language, etc.). Source code 231 is compiled by the compiler 238 into target code 241. As shown, the compiler 238 is coupled to the user interface 206 to expose errors to the programmer that may occur during compilation of the source code 231.

The code editor 211 is arranged to enable source code to be written and edited and will often include features to speed up input of source code such as syntax highlighting, automated completion, and bracket matching functionality. The code editor 211 may also check syntax of the code on-the-fly as it is typed in some implementations. The automation system 220 is configured to automate some of the tasks encountered when developing software. The automation system 220 may include scripting or other automation tools to automate linking and compiling processes, for example, by performing scripted calls to the compiler 238.

The IDE 200 also supports a debugger 246 that typically enables the programmer to observe run-time behavior of a program and locate logical and/or semantic errors in the code. For example, the debugger 246 allows the programmer to break, or suspend, execution of the program to examine the code, evaluate and edit variables in the program, view registers and instructions created from the source code 231, and view the memory space used by the program. Although debuggers can be implemented as standalone functionality, in this example the debugger 246 is accessed via the commonly-utilized user interface 206 in the IDE 200. Some debuggers are configured to work with code at various stages in development, for example as source code (as indicated by arrow 250) and/or as target code (as indicated by arrow 252).

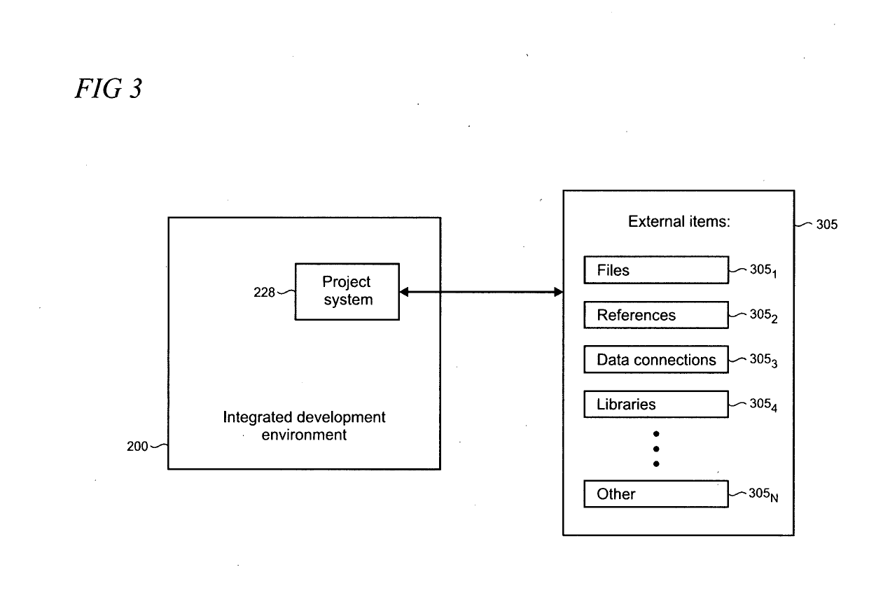

As shown in FIG. 3, the project system 228 is coupled to interact with external items 305 that may be needed or helpful for the programmer to create the desired code. For example, programmers frequently utilize portions of code that is written by other developers which they can link into their own programs. The external items 305, in this example, include files 305₁, references 305₂, data connections 305₃, libraries 305₄, and other items 305_{N}. However, it is emphasized that the items are intended to be illustrative and that other external items can be utilized depending upon the requirements of the specific implementation.

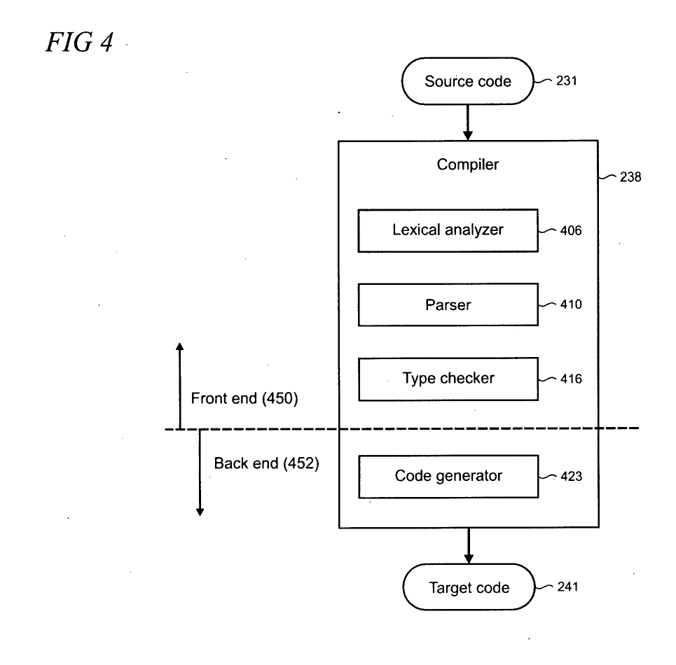

FIG. 4 shows details of the compiler 238 deployed in the IDE 200 (FIG. 2) that is utilized to transform high-level source code 231 into target code 241 such as assembly language, binary object code, or script such as JavaScript. Compiler 238 in this example includes a variety of functional components including a lexical analyzer 406, parser 410, and type checker 416 (which are arranged in what is typically called the “front end” of the compiler 238), and a code generator 423 (which is arranged in the “back end” of the compiler 238).

The components in the front end (indicated by reference numeral 450) are configured to perform conventional functionalities. Here, the lexical analyzer 406 converts a stream of characters into a sequence of tokens which are defined, for example, by regular expressions. The parser 410 then parses the token sequence to identify the syntactic structure of the program. A parse tree can be constructed to replace the linear structure of the token sequence by application of some formal grammar. In some implementations, additional semantic analysis may be performed on the parse tree by performing type checking (in the type checker 416) or other processes to add semantic meaning to the parse tree. It is noted that the particular components utilized in the front end 450 of the compiler 238 and the functionality embodied therein can vary from that shown in FIG. 4 as may be needed to meet the requirements of a particular implementation. For example, various types of high-level and/or low-level optimizations of the compiled code may also be performed.

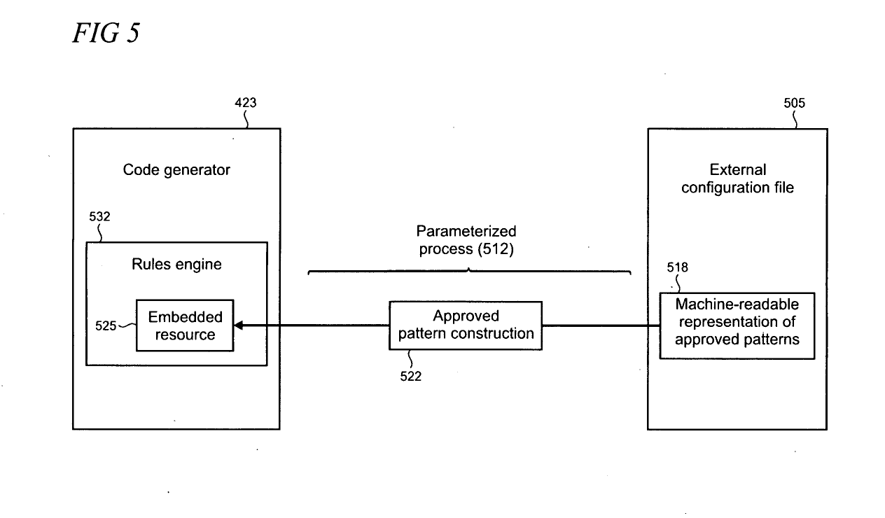

As shown in FIG. 5, in this illustrative example, the code generator 423 in the back end 452 of the compiler 238 is adapted to generate the target code so that it is correct by construction by complying with approved patterns described by an external configuration file 505 that is utilized to parameterize the code generation process (as indicated by reference numeral 512). The external configuration file 505 is arranged to encapsulate a machine-readable representation 518 of acceptable and/or unacceptable patterns. This representation provides an approved pattern construction, as indicated by reference numeral 522 that is utilized as an embedded resource 525 in a rules engine 532 that is disposed in the code generator 423.

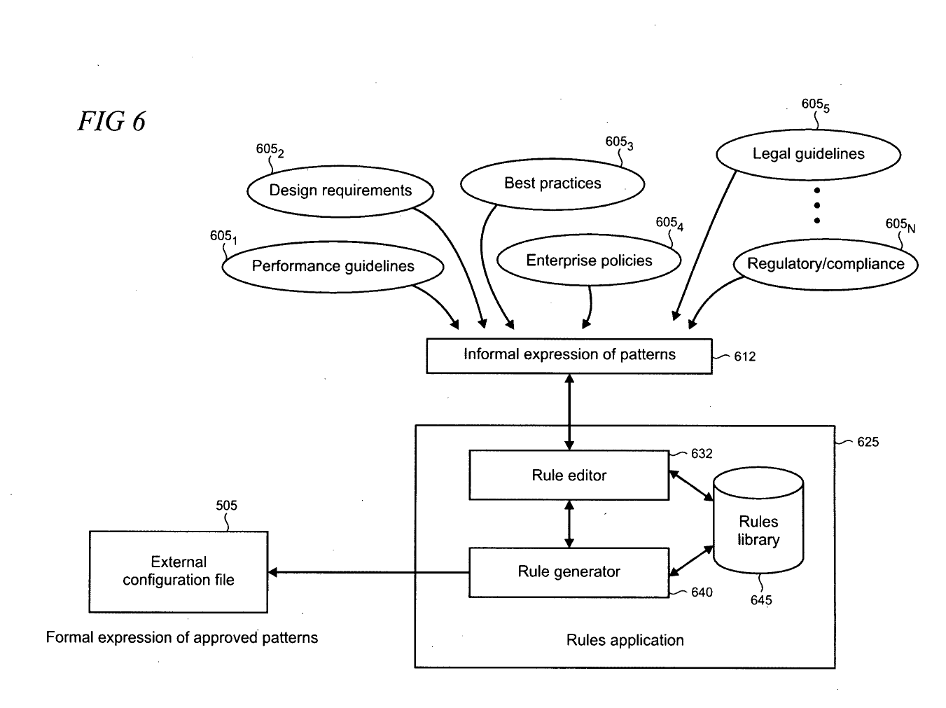

The approved patterns are used in this example to express various types of guidelines (and/or requirements) to which the target code is desired to adhere and can comprise either acceptable patterns that the target code can include or unacceptable patterns that the target code needs to avoid, or both. As shown in FIG. 6, these can include performance guidelines 605₁ for a program, design requirements 605₂, best practices 605₃, enterprise policies 605₄ (or other types of corporate or company policies), legal guidelines 605₅, and regulatory and/or compliance guidelines 605_{N}, and various combinations thereof. For example, the guidelines could deal with such topics as export control, FIPS (Federal Information Processing Standards) restrictions, auditing requirements under the Public Company Accounting Reform and Investor Protection Act of 2002 (also known as the “Sarbanes-Oxley” Act), and the like. Generally, the above guidelines can be broken down into two discrete categories—performance guidelines (i.e., 605₁, 605₂, 605₃) and compliance guidelines (i.e., 605₄, 605₅, and 605_{N}).

It is emphasized that the list above is not intended to be exhaustive and that other types of guidelines may be utilized as may be needed to meet the requirements of a particular implementation. For example, law, regulations, rulings, edicts, or other type of imperatives to which strict adherence is needed can also be incorporated into the approved patterns. Typically, the approved patterns will be expressed informally, as indicated by reference numeral 612, for example by being written in a memorandum, e-mail, or other conventional form.

A programmer may utilize a rules application 625 that exposes a rule editor 632 to enable the informal expression 612 to be formally expressed as the machine-readable representation that is encapsulated in the external configuration file 505 as one or more rules. The rules application 625 may be implemented as a standalone application, or alternatively be deployed as part of the IDE 200 (FIG. 2).

A rule generator 640 will apply regular tree grammar to generate rules that are added to an assembly as the embedded resource 525 (FIG. 5). Typically, a new rule will extend or inherit from a base class to enable some common functionality as well as facilitate code reusability and simplify maintenance. Existing rules and/or classes can be stored in a library 645 and be employed as needed.

Illustrative examples of code generation with approved patterns are now presented. In a first example, the legal guidelines 605₅ may be applicable to a given programming scenario because of license or other legal restrictions on the use of particular programming techniques, user experiences, and the like. Here, it is assumed that strict guidelines for the activation of ActiveX controls in webpages are applicable to the generated target code. It is emphasized, however, that the activation restrictions could be in place for other reasons.

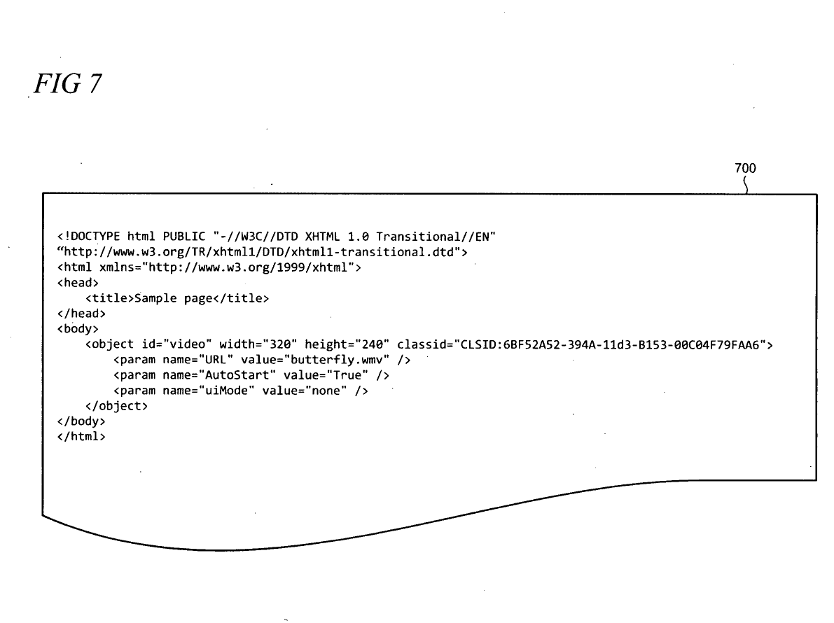

ActiveX controls are typically downloaded and executed by a web browser running on a client computer to establish rules for how applications share information. FIG. 7 includes an HTML (HyperText Markup Language) code sample 700 that shows a typical activation for an ActiveX control in a webpage. As shown, this style of activation will prompt the user of the client computer to “click to activate” the control before it can be used in an interactive manner. However, it is possible to avoid the “click to activate” action by dynamically injecting script into the webpage. In this example, it is assumed that programmers need to adhere to the approved patterns below when authoring the HTML used in the page:

1. A call to an external script function that outputs the APPLET, EMBED, or OBJECT element cannot be parameterized.

2. A reference to an external script file must be located in a separate part of the HTML document than the call to the external script function.

3. A reference to an external script file cannot have parameters passed using a URL (Uniform Resource Locator) or HTTP (Hypertext Transport Protocol) POST method data. Exception: A GUID (globally unique identifier) can be included in the URL if it is not the same GUID as the classid attribute of the <object> tag.

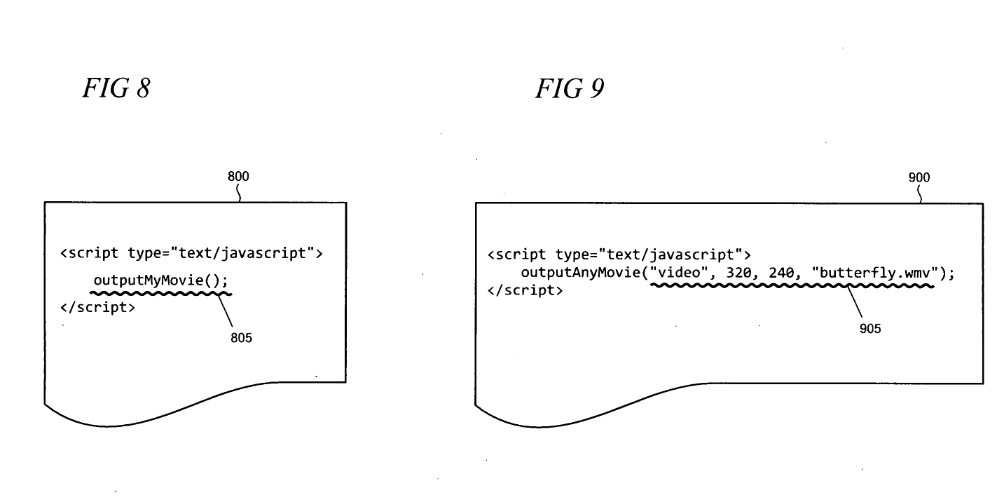

With regard to pattern 1, FIG. 8 shows a code sample 800 that includes a pattern which is acceptable because the call to the external function has no parameters, as indicated by reference numeral 805. By comparison, FIG. 9 shows a code sample 900 that includes a pattern which is unacceptable because the call to the external function has parameters describing the object output, as indicated by reference numeral 905.

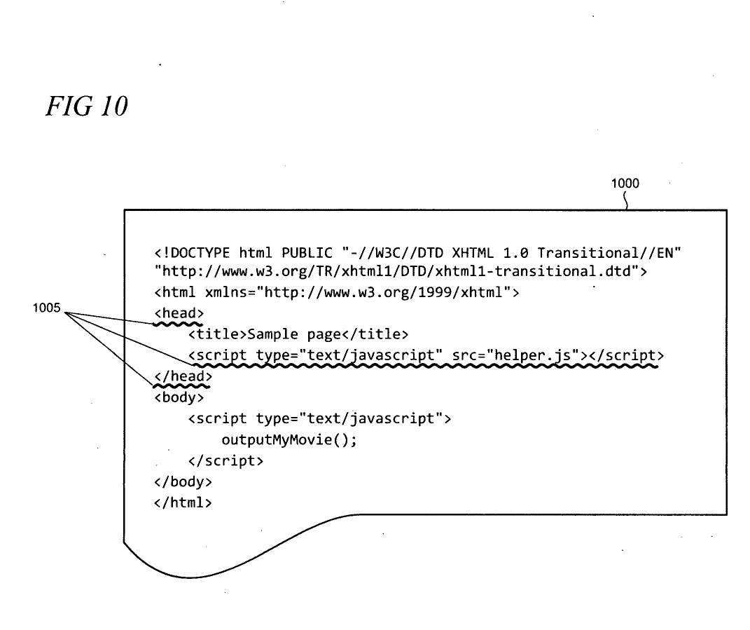

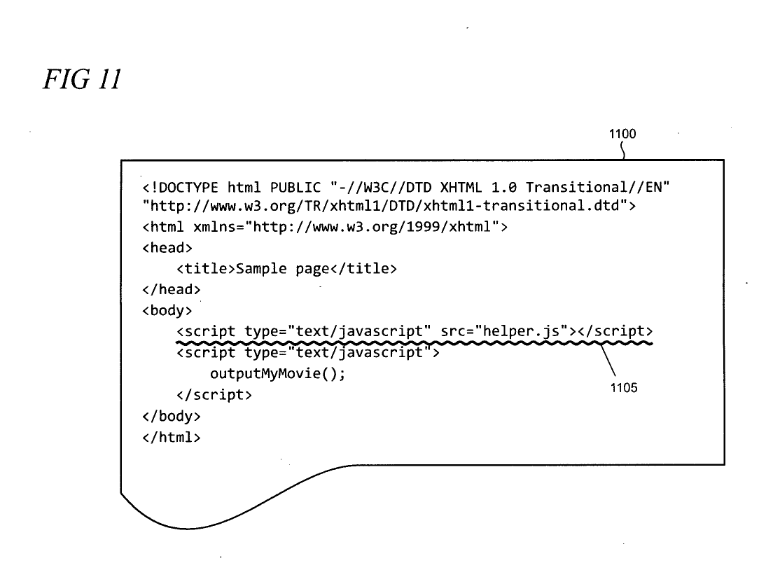

With regard to pattern 2, FIG. 10 shows a code sample 1000 that includes a pattern which is acceptable because the script reference is included in the <head> element as indicated by reference numeral 1005. By comparison, FIG. 11 shows a code sample 1100 that includes a pattern which is unacceptable because the script element is at the same location as the call to the external function, as indicated by reference numeral 1105.

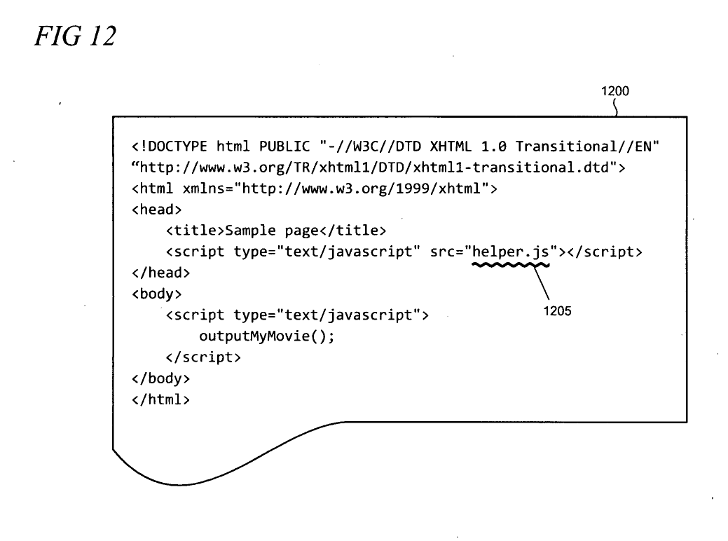

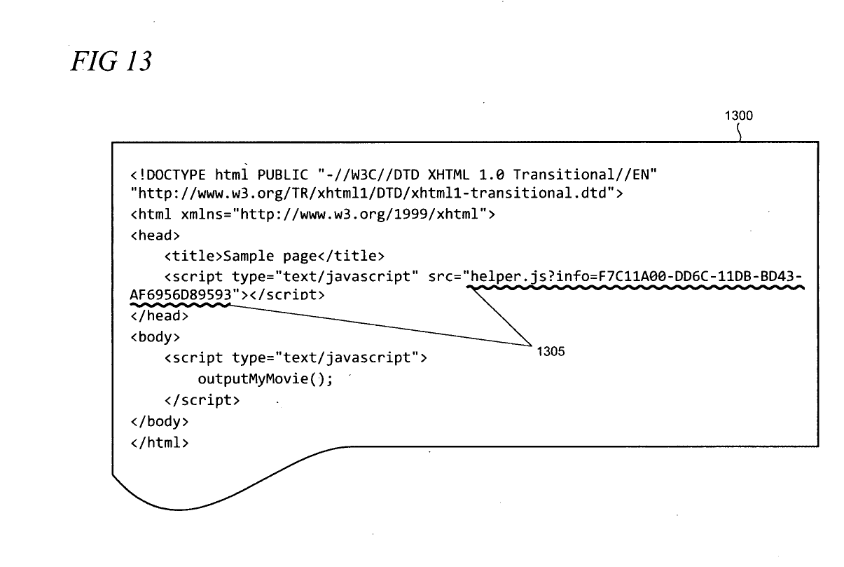

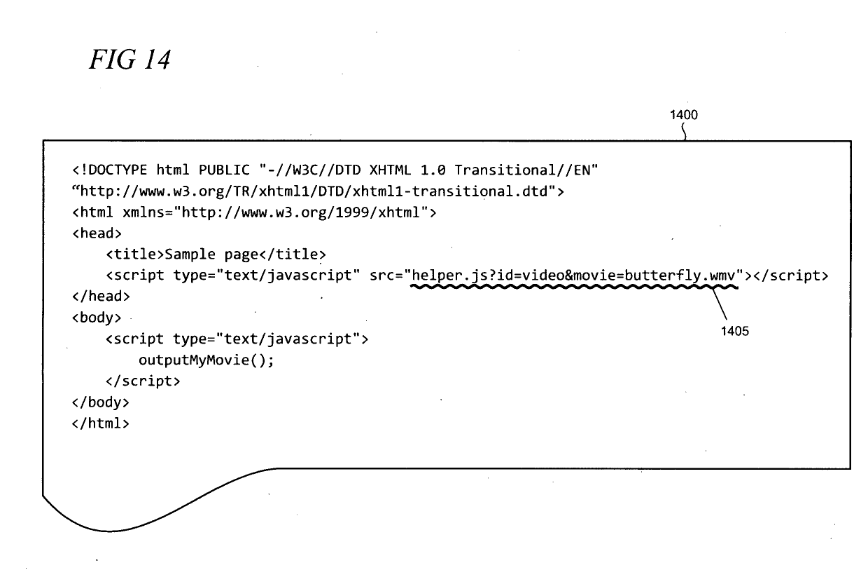

With regard to pattern 3, FIG. 12 shows a code sample 1200 that includes a pattern which is acceptable because the script reference is a simple URL, as indicated by reference numeral 1205. FIG. 13 shows a code sample 1300 that includes a pattern which is acceptable because the script reference has a GUID as part of its URL, as indicated by reference numeral 1305. By comparison, FIG. 14 shows a code sample 1400 that includes a pattern which is unacceptable because the script reference has control-related metadata as part of its URL, as indicated by reference numeral 1405.

Several code generation techniques, or workarounds, can be utilized so that the compiler 238 (FIG. 2) can output target code 241 that complies with the acceptable patterns and avoids the unacceptable patterns. For example, the code generator 423 (FIG. 4) can generate code that uses staging or partial evaluation to generate non-parameterized code. Here, given a parameterized function F(x){ . . . X . . . } that outputs an Object tag (which would thus violate pattern 1), each call of this function to an actual argument, say (F, 4711), can be replaced by a call to another function PartiallyEvaluate(F,4711). This function will dynamically replace the call to the original parameterized function by a non-parameterized special function F_{—}4711( ){ . . . 4711 . . . } that generates the Object tag in which all parameters have been substituted in the partially evaluated code (and thus would not violate pattern 1). In other words, a parameterized function is dynamically replaced by a non-parameterized function during runtime of the target code.

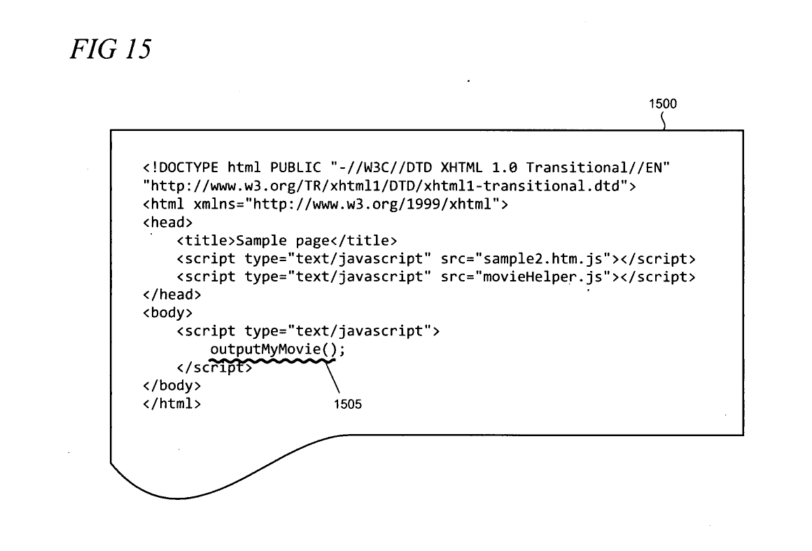

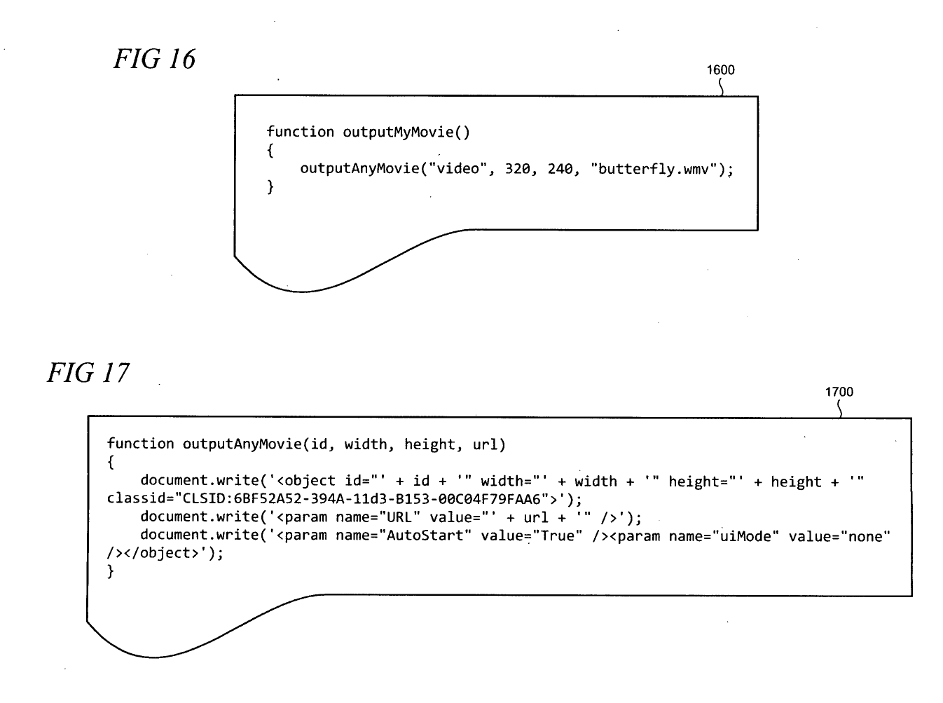

The resulting code will satisfy the acceptable pattern shown in FIG. 15 (where the call to the external function has no parameters, as indicated by reference numeral 1505). Any call to the parameterized function outputAnyMovie(“video”, 320, 240, “butterfly.wmv”) shown in the code sample 1600 in FIG. 16 will generate a call to the non-parameterized function outputAnyMovie( ) using the specialized function shown in the code sample 1700 in FIG. 17 with which the parameters are substituted.

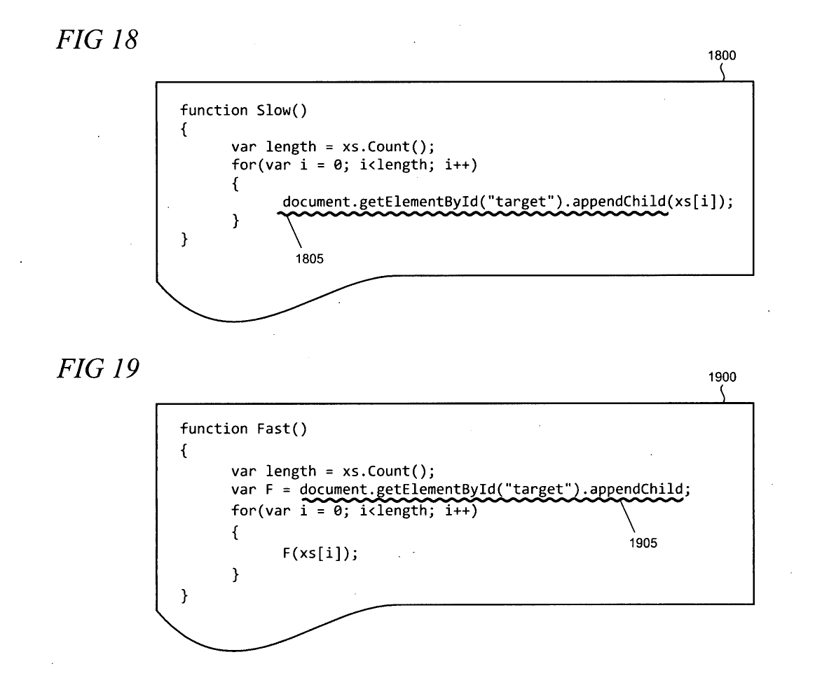

In the second illustrative example of code generation, certain unacceptable patterns are avoided where the target code is constrained and cannot be implemented properly or efficiently. For example, in some versions of the Microsoft Internet Explorer® brand web browser, the implementation of JavaScript does relatively little caching of member lookup (i.e., a process in which the meaning of a member name in the context of a type is determined). In the code sample 1800 shown in FIG. 18, the expression indicated by reference numeral 1805 is evaluated at each iteration of the loop. This is an example of a pattern that is better to be avoided. The execution of the code can be sped up considerably by hoisting the expression out of the loop which effectively caches the result of the member lookup in the function pointer F. This acceptable pattern is shown in the code sample 1900 displayed in FIG. 19 which shows the expression above the loop, as indicated by reference numeral 1905.

Similar optimizations for JavaScript running on Internet Explorer can be embodied in other patterns, for example, by caching local variables and function pointers whenever possible, avoiding the use of expensive functions such as eval, optimizing string manipulations by avoiding intermediate results, avoiding use of closures and property accessor functions, and a variety of other known techniques as described, for example, at http://blogs.msdn.com/ie. These and similar techniques may be encapsulated as acceptable and unacceptable patterns in the external configuration file 505 described above in the text accompanying FIG. 5.

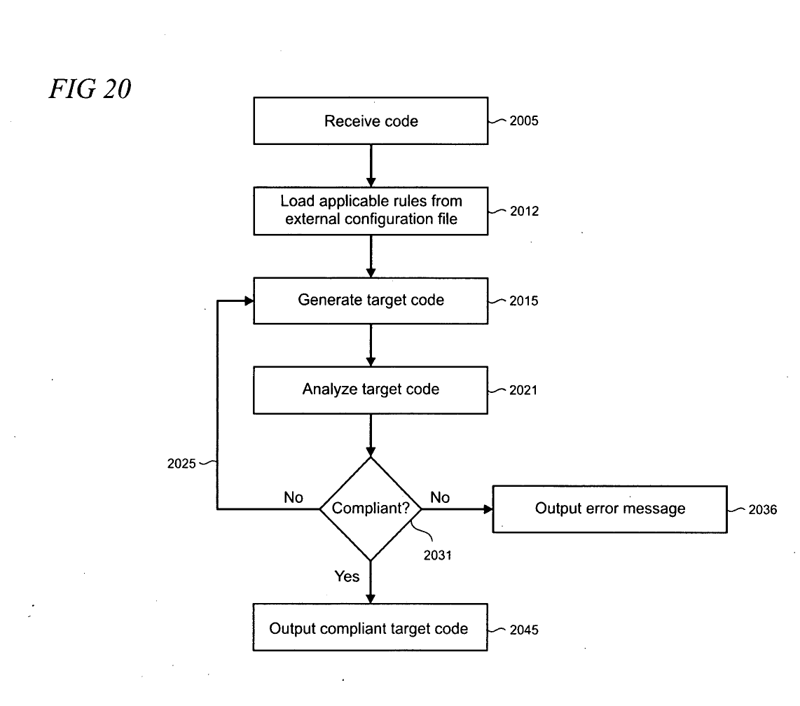

FIG. 20 is a flowchart of an illustrative method that can be performed by the code generator 423 shown in FIGS. 4 and 5 and described in the accompanying text. The code generator 423 receives code from one of the other components in the compiler (as indicated by reference numeral 2005) and loads the applicable rules that define an approved pattern construction from the external configuration file (2012). The code generator 423 generates the target code (2015) which is analyzed to determine compliancy with the patterns (2021) where the rules function as a code parser.

In some cases, multiple passes may need to be made to achieve compliance with the patterns, as shown by path 2025 from the decision block 2031.

That is, the target code is utilized in a feedback loop back to the compiler to ensure that the output of the code generator is correct by construction and complies with the desired patterns. If, after some predetermined number of passes (which may include just a single pass), the source code cannot be reduced to compliant target code, then an error message is output (2036) which can be displayed to the programmer via the user interface 206 in the IDE 200 (FIG. 2). For example, the target code may be constrained in some way that prevents it from being compliant with the approved patterns, or there is no available workaround. Alternatively, the error message or warning can be generated for either actual or potential violations of the approved patterns by the target code. If the target code is found to be compliant with the desired patterns, then it is output by the code generator 423 (2045).

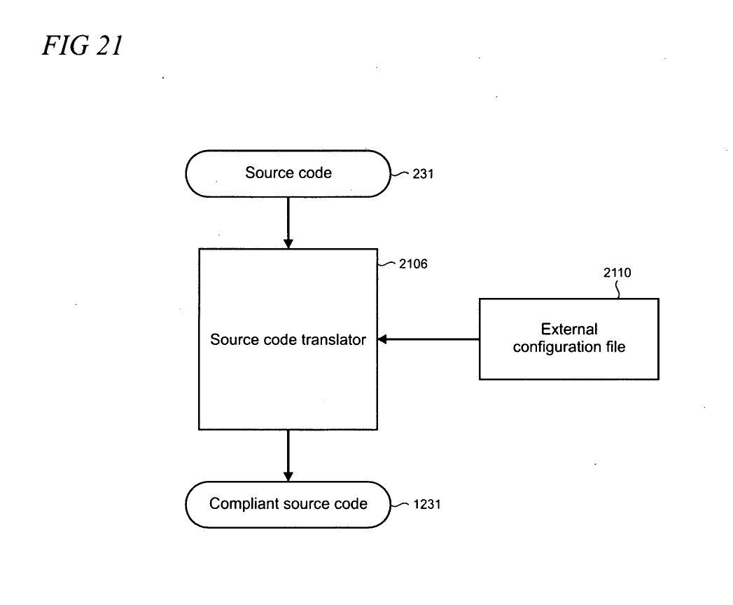

FIG. 21 shows an alternative implementation that may be used for creating source code that is compliant with desired patterns. In this example, a source code translator 2106 is utilized to perform source-to-source transformation of original source code 231 into compliant source code 1231. An external configuration file 2110 may be used to parameterize the transformation process in a similar manner as used with the code generator 423, as described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable storage media containing instructions which, when executed by one or more processors disposed in an electronic device, perform a method for compiling source code into target code, the method comprising the steps of:
applying a front end compilation process to the source code, the source code being written in a high-level programming language;
loading, as resources in a rules engine, one or more rules from an external configuration file, the one or more rules representing an approved pattern, the approved pattern expressing at least one of performance guideline for the target code or compliance guideline for the target code;
generating the target code in a back end code generation process in view of the one or more rules;
analyzing the generated target code for compliance with the approved pattern; and
outputting the target code if the target code is determined to be compliant with the approved pattern.

2. The one or more computer-readable storage media of claim 1 in which the method includes a further step of outputting an error message if the target code is determined to be irreducible to a form that is compliant with the approved pattern.

3. The one or more computer-readable storage media of claim 1 in which the generating comprises implementing a workaround to replace an unacceptable pattern in the target code with an acceptable pattern.

4. The one or more computer-readable storage media of claim 3 in which the workaround comprises a function substitution that is performed dynamically at runtime of the target code.

5. The one or more computer-readable storage media of claim 3 in which the workaround comprises avoiding a given pattern for which the target code is constrained from handling.

6. The one or more computer-readable storage media of claim 1 in which the method for compiling source code is performed in an integrated development environment.

7. The one or more computer-readable storage media of claim 1 in which the front end compilation process includes at least one of lexical analysis, parsing, or type checking.

8. The one or more computer-readable storage media of claim 1 in which the target code is one of script, code expressed in low-level assembly language, or binary object code.

9. A computer-implemented method for performing a transformation of original code to compliant code, the method comprising the steps of:
receiving a description of approved patterns to which the compliant code is to adhere, the approved patterns comprising acceptable patterns or unacceptable patterns;
generating code to incorporate the acceptable patterns or avoid the unacceptable patterns; and
using one or more rules to parse the generated code to verify compliance with the approved patterns.

10. The computer-implemented method of claim 9 in which the transformation is implemented in a compiler that transforms high-level source code to low-level target code.

11. The computer-implemented method of claim 9 in which the transformation is implemented in a source-to-source translator that transforms original source code to compliant source code.

12. The computer-implemented method of claim 9 in which the approved patterns describe at least one of performance requirement, performance requirement, enterprise policy, best practice, legal guideline, regulation, compliance guideline, or imperative.

13. The computer-implemented method of claim of 9 in which the approved patterns are encapsulated in an external configuration file that is usable for parameterizing the transformation.

14. The computer-implemented method of claim 9 in which the compliant code is correct by construction without modification to the original code.

15. The computer-implemented method of claim 9 including a further step of generating a warning for actual or potential violations of the approved patterns.

16. The computer-implemented method of claim 9 in which the approved patterns govern utilization of an ActiveX control in a webpage or utilization of JavaScript in a webpage.

17. One or more computer-readable storage media containing instructions which, when executed by one or more processors disposed in an electronic device, perform a method for parameterizing generation of target code, the method comprising the steps of:
exposing a user interface configured for capturing informal expressions of approved patterns;
applying regular tree grammar to the informal expressions to transform the informal expressions into rules comprising one or more machine-readable expressions of the approved patterns; and
encapsulating the one or more machine-readable expressions in an external configuration file, the external configuration file providing the approved patterns as a resource to a code generator that is utilized when generating the target code.

18. The one or more computer-readable storage media of claim 17 in which the user interface is further configured for accepting user input to creating the rules.

19. The one or more computer-readable storage media of claim 18 in which the created rules are extended from a rules base class.

20. The one or more computer-readable storage media of claim 17 in which the rules are usable to parse the target code to verify compliance with the approved patterns.
